(19) United States
(12) Patent Application Publication
(10) Pub. No.: US 2007/0161374 A1
(43) Pub. Date: Jul. 12, 2007

(54) Co-channel handover in a cellular network

(75) Inventors: Kip W.G. Kienstra III, Indian Harbour Beach, FL (US); Terry L. Williams, Melbourne Beach, FL (US)

Correspondence Address: SACCO & ASSOCIATES, PA, P.O. BOX 30999, PALM BEACH GARDENS, FL, 33420-0999, US

(73) Assignee: AirNet Communications Corporation, Melbourne, FL (US)

(21) Appl. No.: 11/329,607

(22) Filed: Jan. 11, 2006

(51) Int. Cl. H04Q 7/20

(52) U.S. Cl. 455/436

(57) ABSTRACT

Method for transferring service for a mobile station call signal from a first base transceiver station to a second base transceiver station in a wireless mobile telecommunication system. The first base transceiver station can automatically terminate RF transmissions from the first base transceiver station to the mobile station on a pre-handover RF channel. Thereafter, telecommunication service for the mobile station can be automatically continued using the second base transceiver station. Advantageously, the second base transceiver station can provide the telecommunication service for the mobile station on a post-handover radio frequency channel that is the same as the pre-handover radio frequency channel.

### BACKGROUND OF THE INVENTION

1. Statement of the Technical Field

The inventive arrangements relate to cellular telephone systems and more particularly to handover of mobile stations from one base station to another.

2. Description of the Related Art

Cellular communication systems generally consist of base stations that transmit and receive radio signals with numerous mobile stations. These communications occur simultaneously on different radio channels of each base station. Conventional base stations commonly employ broad beam antennas to support radio signal coverage over large geographic areas, with each base station intended to cover a different area. The coverage area of a base station will overlap to some extent with the coverage areas of adjacent base stations. These areas of overlap are generally at the outer regions of each base station's coverage areas.

The basic architecture of cellular communication systems and the mobile nature of mobile stations are such that the system does not rely on a fixed set of radio links. Consequently, a call in a cellular communication system is often switched among a plurality of different channels or cells. This process is called handover or handoff.

Due to limited radio spectrum, cellular systems typically employ frequency reuse. This is the repeated use of the same radio frequency channels by multiple base stations throughout a cellular network. The use of the same frequency channels by different mobiles and base stations can cause interference between users of the same frequency channel, known as co-channel interference. To limit co-channel interference, base stations using the same radio channels must be geographically separated by a sufficient distance. A cellular system may employ a frequency reuse of 7, or N=7. This indicates that the same frequency channel may be used in 1 out of 7 base stations in a pattern that attempts to limit co-channel interference. Frequency reuse constrains the overall capacity in a cellular network. The lower the reuse number, the higher the frequency reuse and the greater overall network capacity. For example, a network that has a reuse of N=1 has 7 times the capacity of that using a reuse of N=7. However, in a typical cellular network a frequency reuse of N=1 (or even reuse levels near this level) is not achievable due to co-channel interference.

There are numerous methods that are used to reduce or distribute co-channel interference to allow greater frequency reuse. For example, adaptive antenna arrays can be used to reduce interference by focusing RF energy towards an intended recipient while reducing RF energy directed towards un-intended co-channel users of the same frequency channel. In general, this technique is known as adaptive array spatial processing. This is accomplished using an array of antenna elements whereby RF energy is electronically steered by adapting the phase and amplitude of radio signals transmitted and received through the antenna array. Adaptive arrays provide significant benefits with regard to addressing the problem of co-channel interference. These systems have the ability to control where the radio signal is received or not received based on spatial properties of the signal.

Adaptive focus and nulling is an adaptive array spatial processing technique in which the spatial properties of transmitters received in an uplink signal are analyzed and a solution for the downlink transmission is determined. The desired downlink signal results in a spatial solution that will “focus” RF energy at the geolocation of the intended receiver while reducing or “nulling” RF energy at the geolocations of co-channel users on the same radio channel, thus reducing co-channel interference.

Adaptive array spatial processing provides the capability to support high frequency reuse patterns, such as an N=1 pattern, using a TDMA wireless protocol such as GSM, whereby adjacent cell may used the same physical radio channels. The adaptive array processing filters each RF signal based on the spatial properties of the signal. During the handover process, both the originating and target base stations are transmitting, but in a typical non-adaptive network these would always be different physical channels. When performing handovers between base stations, high frequency reuse introduces the possibility that the originating and target radio channel for handover is the same physical radio channel. When both the originating and target base stations are transmitting to the same mobile on the same channel, the level of mutual interference can be such that the mobile is not able to receive and demodulate the received signal from either base station. This problem severely limits the ability of one base station to make co-channel handovers to another base station.

### SUMMARY OF THE INVENTION

A first embodiment of the invention concerns a method for transferring service for a mobile station call signal from a first base transceiver station to a second base transceiver station in a wireless mobile telecommunication system, where the first and second base transceiver station include a plurality of common radio frequency channels for traffic communication with mobile stations. The method eliminates the possibility that communications on the second base transceiver station will be initiated on the same frequency as service on the first base transceiver station. Such a handover can result in high levels of interference at the mobile unit and can result in dropped calls.

In this first embodiment, the handover process can begin when a handover request message is received at the second base transceiver station. The handover request message can include a request for the second base transceiver station to provide a telecommunication service to a mobile station. For example, this can occur when the mobile station is currently obtaining such telecommunication service from the first base transceiver station but is moving out of range of range of that station. When the handover request is received, a current radio frequency channel in use by the mobile station to communicate with the first base transceiver station can be compared to a set of available radio channels on which the mobile station could obtain the required telecommunication service from second base transceiver station. The purpose of the comparison can be to determine if the set of available radio channels includes at least one post-handover radio frequency channel for communications between the mobile and the second base transceiver station exclusive of the current radio channel. A co-channel handover can thereafter be performed only if there is at least one frequency channel available on which the second base transceiver can communicate with the mobile station that will not cause interference with the first base transceiver station's communications with the mobile.

If there is at least one available radio frequency channel on the second base station that is exclusive of the current radio channel the mobile is using to communicate with the first base transceiver station, then the an acceptance of the handover request can be communicated from the second base transceiver. This acceptance can be transmitted to a base station controller, a mobile services switching center (MSC), and/or the first base transceiver station. Conversely, a refusal of the handover request can be communicated by the second base transceiver if the set of available radio channels does not include at least one post-handover radio frequency channel exclusive of the current radio channel. In this way, co-channel handovers can be avoided.

A second embodiment of the invention also concerns a method for transferring service for a mobile station call signal from a first base transceiver station operating on a first set of radio frequency channels, to a second base transceiver station operating on a second set of radio frequency channels in a wireless mobile telecommunication system. Once again, the transfer can occur while the call is in progress. Moreover, the first and the second sets of radio frequency channels can include a number of common radio frequency channels.

In this second embodiment, a first base transceiver can provide a telecommunication service to a mobile station on a pre-handover RF channel used by the first base transceiver station to communicate with the mobile station. In response to a handover command message, the first base transceiver station can automatically terminate RF transmissions from the first base transceiver station to the mobile station on the pre-handover RF channel. Thereafter, telecommunication service for the mobile station can be automatically continued using the second base transceiver station. Advantageously, the second base transceiver station can provide the telecommunication service for the mobile station on a post-handover radio frequency channel that is the same as the pre-handover radio frequency channel that had previously been in use by the first base transceiver station.

According to one aspect of the invention, the first base transceiver station can also transmit a handover command message to the mobile station prior to the terminating step. This handover command message can direct the mobile station to continue the telecommunication service with the second base transceiver station. The first base transceiver station can continue to monitor transmissions from the mobile station after the handover command message is transmitted. However, transmissions to the mobile station from the first base transceiver station can be terminated immediately after the handover command message is transmitted. Thereafter, such transmissions can be re-initiated on the pre-handover RF channel if the first base transceiver station continues to receive certain types of messages directed to it from the mobile station after a pre-determined period of time. Such messages can include (1) a signal measurement report from the mobile station, or (2) a handover failure message indicating that the mobile station has been unable to obtain the telecommunication service from the second base transceiver station.

Instead of simply terminating transmissions to the mobile station after transmitting a handover command to the mobile station, it can be desirable for the base transceiver station to first determine if the mobile station has received the handover command method from the first base transceiver station. Accordingly, the first base transceiver station can terminate transmissions to the mobile station only after receiving at the first base transceiver station at least an indirect acknowledgment of the handover command from the mobile station. For example, the indirect acknowledgment can be selected to include an acknowledgment of receipt of a data frame by the mobile station, where the data frame that has been acknowledged is known by the first base transceiver station to have contained the handover command.

Transmissions from the second base transceiver station to the mobile station on the post-handover radio frequency channel can begin after receiving a handover access message from the mobile station requesting telecommunication services to be provided by the second base transceiver station. Transmissions from the second base station to the mobile station can be automatically terminated if a message confirming that the handover process is complete is not received by the second base station. For example, termination of transmission can occur if a confirmation is not received prior to a predetermined number of transmissions of an information message from the second base transceiver station to the mobile station at a predetermined time interval, or within a predetermined time period.

A handover failure message can be transmitted from the mobile station to the first base transceiver station on the pre-handover RF channel if an information message from the second base transceiver station is not received by the mobile station within a second predetermined time period. Transmissions from the second base station to the mobile station can be terminated prior to transmitting the handover failure message. In any case, a telecommunication resource of the first base transceiver station can be released from service with respect to the mobile station only after the second base transceiver station receives a message from the mobile station confirming that the telecommunication service with the second base transceiver station has been established.

It should be understood that prior to the terminating step, the first base transceiver station communicates with the mobile station during a first defined burst period. After such terminating step, the second base transceiver station can communicate with the mobile station during a second burst period. Significantly, the first and second burst periods can be substantially overlapping in time.

According to another embodiment of the invention, the terminating step and the step of continuing the telecommunication service for the mobile station using the second base transceiver station can occur exclusive of any notification to the mobile station.

### BRIEF DESCRIPTION OF THE DRAWINGS

FIG. 1 is a drawing that shows a conventional architecture of a wireless telecommunication system.

FIG. 2 is a block diagram that is useful for understanding a basic architecture of a wideband base transceiver station that includes adaptive antenna processing.

FIG. 3 is a drawing that is useful for understanding the handover process in a wireless telecommunication system.

FIG. 4 is a process flow diagram that is useful for understanding a handover process.

FIGS. 5a and 5b are drawings that are useful for understanding a burst structure in a GSM base wireless telecommunication system.

FIG. 6 is a drawing that is useful for understanding an access burst in a GSM based wireless telecommunication system.

FIG. 7 is a flowchart that is useful for understanding a method for avoiding co-channel handovers.

FIG. 8 is a process flow diagram that is useful for understanding a method for performing a co-channel handover.

FIG. 9 is a variation of the method in FIG. 8 that shows a procedure for responding to a handover error scenario.

FIG. 10 is a variation of the method in FIG. 8 that shows a procedure for responding to a second handover error scenario.

FIG. 11 is a process flow diagram that is useful for understanding an alternative method for performing a co-channel handover.

FIG. 12 is a variation on the method in FIG. 11 that shows a procedure for responding to a handover error scenario.

### DETAILED DESCRIPTION OF THE PREFERRED EMBODIMENTS

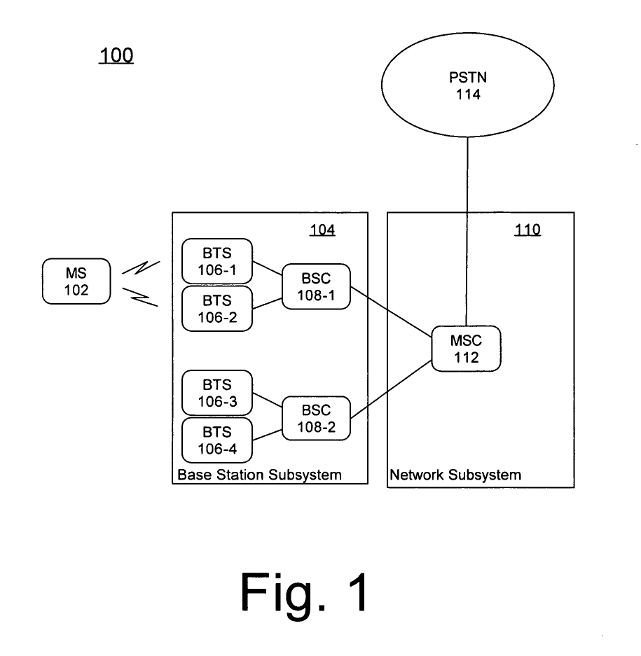

FIG. 1 shows the architecture of a wireless mobile telecommunication system 100. The architecture shown is for a GSM based system. However, it should be understood that the inventive arrangements are not limited to use in GSM systems. Accordingly, the architecture shown is provided merely by way of example for better understanding the present invention. As shown in FIG. 1, a wireless mobile telecommunication system 100 based on the GSM standard can include a Mobile Station (MS) 102 that includes a Subscriber Identification Module (SIM) and the Mobile Equipment. The system also includes a Base Station Subsystem 104 that controls the radio link with the MS. A Network Subsystem 110 performs switching of calls. The Network Subsystem 110 can switch calls between mobile users, and between mobile users and wired network users. A primary component of the Network Subsystem 110 is the Mobile services Switching Center (MSC) 112. The MSC 112 connects calls within the GSM network and/or acts as a gateway to the Public Switched Telephone Network 114 or other networks.

The Base Station Subsystem 104 can include a plurality of Base Transceiver Stations (BTS) 106-1, 106-2, 106-3, 106-4. Each BTS contains radio equipment for radio communications with a plurality of MS's 102. Each BTS is responsible for providing radio communications with MS units within an assigned cell. The Base Station Subsystem 104 can also include a plurality of Base Station Controllers (BSC) 108-1, 108-2. Each BSC 108-1, 108-2 can supervise the operation of two or more BTS units.

A BTS can utilize an adaptive antenna array to focus RF energy in a desired direction. According to one embodiment, the adaptive antenna array can be a so called smart antenna array that uses adaptive signal processing to focus RF energy in a desired direction and position nulls at interference sources. Adaptive antenna systems of this type are well known in the art. The direction in which RF energy is focused can be determined by analyzing spatial properties of a received signal coming from the MS.

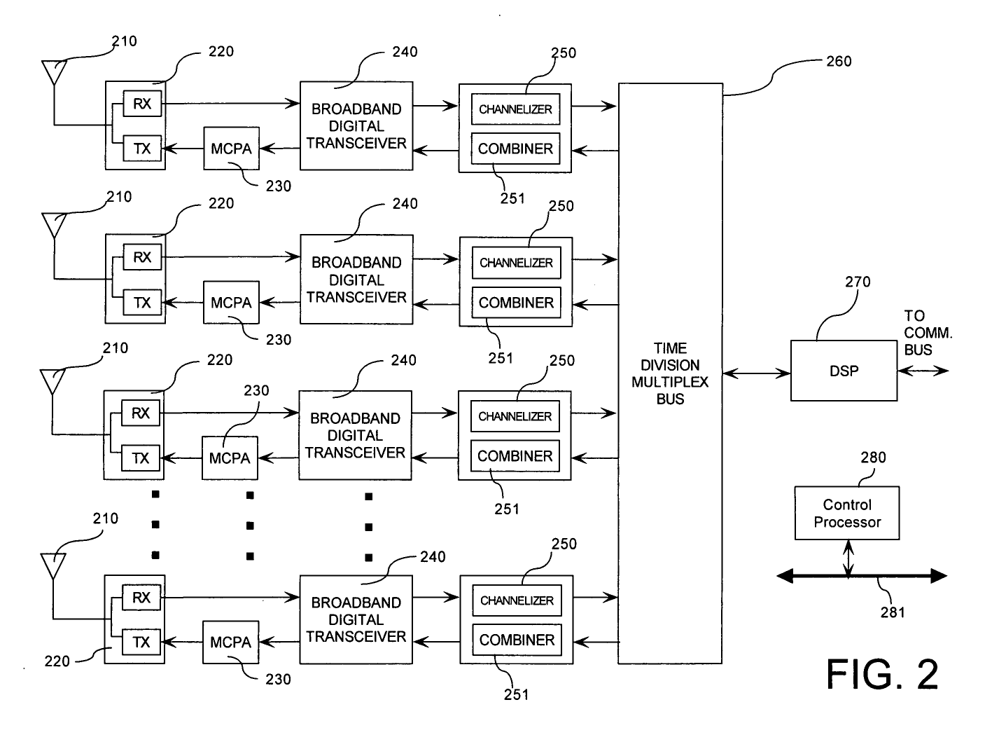

Referring now to FIG. 2, there is shown an example of a BTS that includes an adaptive array antenna system. The adaptive array can have a selected number of antenna elements 210. Each antenna element can have a dedicated receive apparatus chain comprising duplexer 220, broadband digital transceiver 240, and a channelizer/combiner 250 (including analog to digital converter). A suitable interface such as time division multiplex bus 260 can be provided for facilitation of communications between the dedicated receive apparatus chain and digital signal processor board (DSP) 270. The DSP 270 can provide signal processing, for example beam forming, signal modulation, signal calibration, etc. DSP 270 can include a plurality of individual digital signal processors for performing these tasks for each channel.

For transmission, each antenna element 110 has a dedicated transmit apparatus chain comprising duplexer 220, multi-carrier power amplifier (MCPA) 230, broadband digital transceiver 240, combiner 251 (including digital to analog converter), time division multiplex bus 260, DSP 270, and associated connectors inclusive. Similar to its function on the receive path, DSP 270 can perform adaptive array beam forming. DSP 270 can also apply any other desired signal processing to the transmit signals.

A control processor 280 can be provided for controlling the operation of the major system components including the bus 260, and each channelizer 250, combiner 251, broadband digital transceiver 240, MCPA 230. The control processor can communicate with these system components using a control bus 281. Where an adaptive array approach is used, the control processor 280 can adjust a phase, amplitude or both for RF signals associated with all of the plurality of antennas of the antenna array. These operations can be performed in the channelizer and combiner blocks or within DSP 270. In this way the system can combine the RF signals to create an antenna pattern comprising a major lobe exhibiting gain in a direction of one of the plurality of mobile stations 102. The control processor 280 can also adjust the phase and/or amplitude of RF signals associated with each of the plurality of antennas 110 of the antenna array for combining the RF signals to create an antenna pattern comprising nulls in the direction of at least one other of the plurality of mobile stations concurrently operating on the common RF carrier frequency.

Handover Procedures

A handover is the switching of an on-going call to a different channel or cell. Various types of handovers can occur depending upon the architecture of the communication system. For example, in the GSM system, internal handovers within a cell can occur when transferring an ongoing call between different channels or burst periods of a serving cell. In contrast, external handovers can occur when transferring a call between (1) separate BTSs that are under the control of a common BSC, (2) BTSs under the control of different BSCs, where the BSCs are under the control of the same MSC, or (3) BTSs under the control of separate BSCs, where the BSCs are not under the control of the same MSC. External handovers usually occur when an MS communicating through one BTS moves from the coverage area of that BTS to the coverage area of another BTS. To maintain the call, the MS must transition from communicating with the current serving BTS to communicating with the BTS that the mobile is moving towards.

In order to identify when handover should occur and which cell the handover should be directed to, information is needed regarding the quality of the connection and signal power levels in adjacent cells. For example, in the mobile communication system known as GSM (Global System for Mobile Communications), each MS monitors a power level and signal quality (downlink signal) from the BTS of a cell that is currently serving the particular MS. The MS also monitors downlink signal power levels for BTSs in neighboring cells. Conversely, the BTS of each cell also monitors the power levels and quality of uplink signals received from mobile stations that it serves. The handover process can be triggered when this uplink or downlink monitoring indicates that low signal levels and/or poor signal quality exist in a current cell, and it is determined that an improved link quality can be obtained from an adjacent cell. Handover can also be initiated when the monitoring reveals that lower transmission power levels can be used for communications with a neighboring cell. Typically, this situation can arise when the MS is in a boundary region between adjacent cells.

The handover process can include more or fewer steps depending on the type of handover. The following flow process example describes an intercell handover process where the originating and target cells are managed by the same BSC. However, it should be understood that the invention is also applicable to other handover situations. For example, the inventive arrangement can also be utilized in those situations where the handover involves BTS units managed by different BSCs.

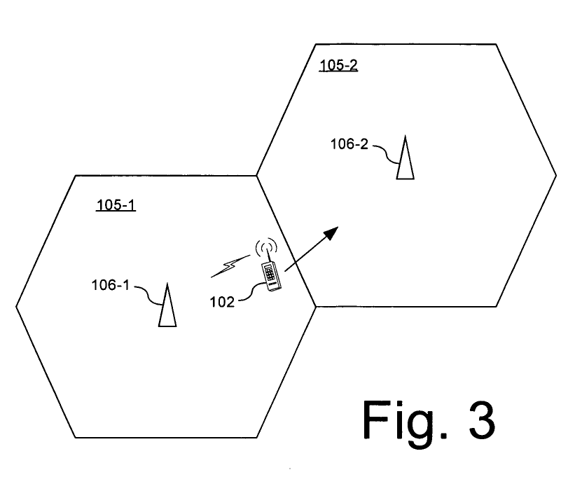

Referring again to FIG. 1, the handover process can begin when a BTS 106-2 determines that a handover should occur for MS 102 that is currently being served. This situation is illustrated in FIG. 3 where MS 102 is shown moving from cell 105-1 containing BTS 106-1 toward cell 105-2 containing BTS 106-2.

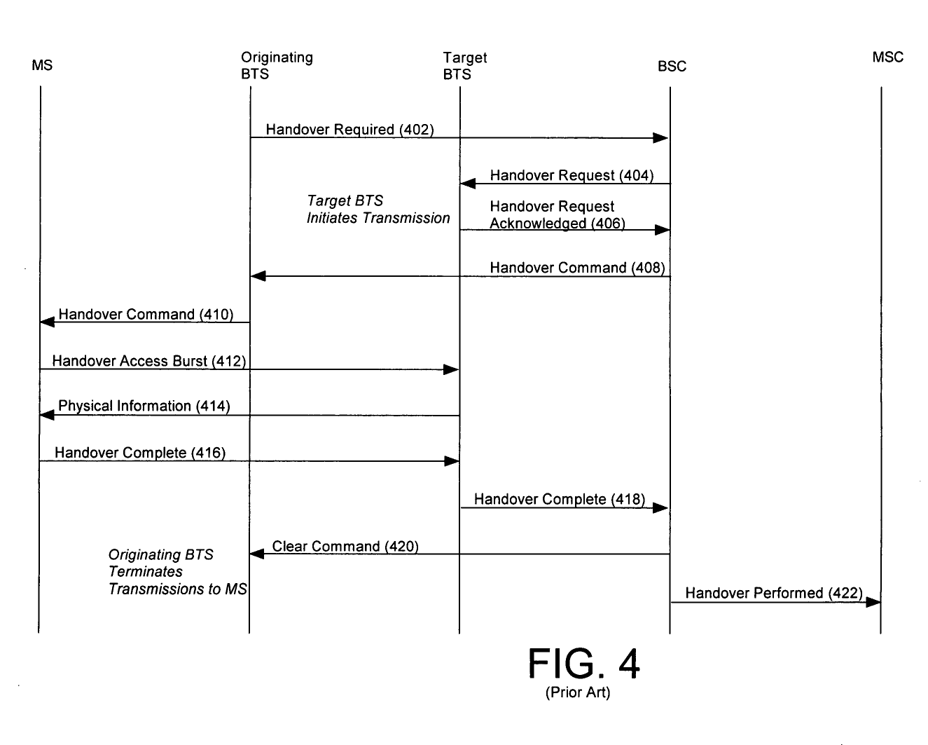

FIG. 4 is a message flow diagram that depicts an intercell handover process where the originating and target cells are managed by the same BSC. The message flow can be somewhat different where the target cells are managed by different BSCs. However, the handover process in FIG. 4 is nevertheless useful for understanding the invention.

Referring now to FIGS. 1-4, the originating BTS 106-1 will send a handover request notification message 402 to the BSC 108-1. The message 402 will notify the BSC 108-1 that a handover is required for a particular mobile station MS 102. The BSC will forward the handover request to target BTS 106-2 in a message 404 to notify the BTS 106-2 that it is to begin serving MS 102. This request will be acknowledged to the BSC 108-1 by the BTS 106-2 in a message 406. Thereafter the BSC 108-1 will send a handover command message 408 to originating BTS 106-1. Once the handover command message is received by BTS 106-1 it will forward the handover command message to MS 102 in message 410. Thereafter MS 102 will initiate a radio link with the BTS 106-2 in message 412. In particular, MS 102 will typically send a handover access burst to BTS 106-2 on a TCH/FACCH channel to initiate the radio link. The BTS 106-2 will respond to MS 102 with physical information message 414. The physical information message 414 includes physical channel information for MS 102. The MS 102 will acknowledge this channel assignment in message 416 by communicating to the BTS 106-2 that the handover is complete. Typically, this message is communicated by the MS 102 using a TCH/FACCH channel. BTS 106-2 will forward this confirmation to the BSC 108-1 in message 418. BTS 106-2 will in turn communicate a command message 420 to the originating BTS 106-1 that it is no longer responsible for communicating with MS 102. The BSC will also send a message 422 to report to the MSC 112 that the handover is complete.

The foregoing description of the handover process is useful for understanding the invention. In this regard, a more detailed description of the various handover procedures can be found in “The GSM System for Mobile Communications” by Michel Mouly and Marie-Bernadette Pautet, 1992 (ISBN: 2-9507190-0-7). The entire disclosure of this publication is incorporated herein by reference. Still, it should be understood that the present invention is not limited to the handover procedures referred to herein. Instead, the invention can be applied to any handover procedure of a wireless cellular communication system.

GSM Burst Structure

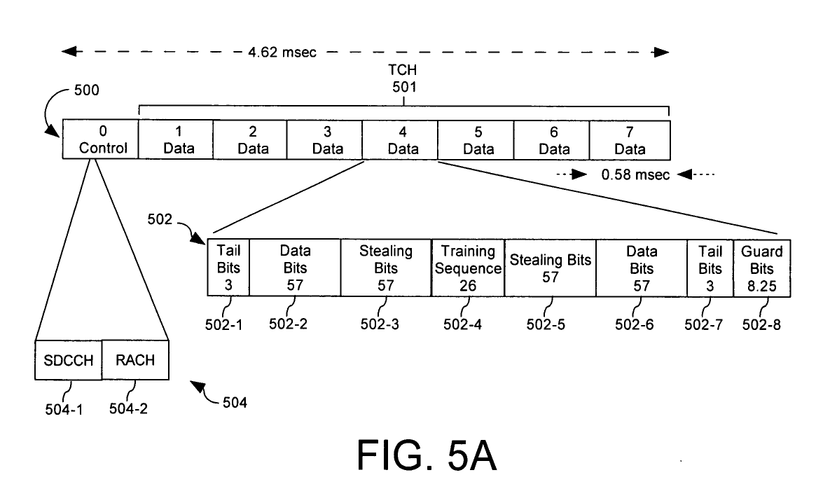

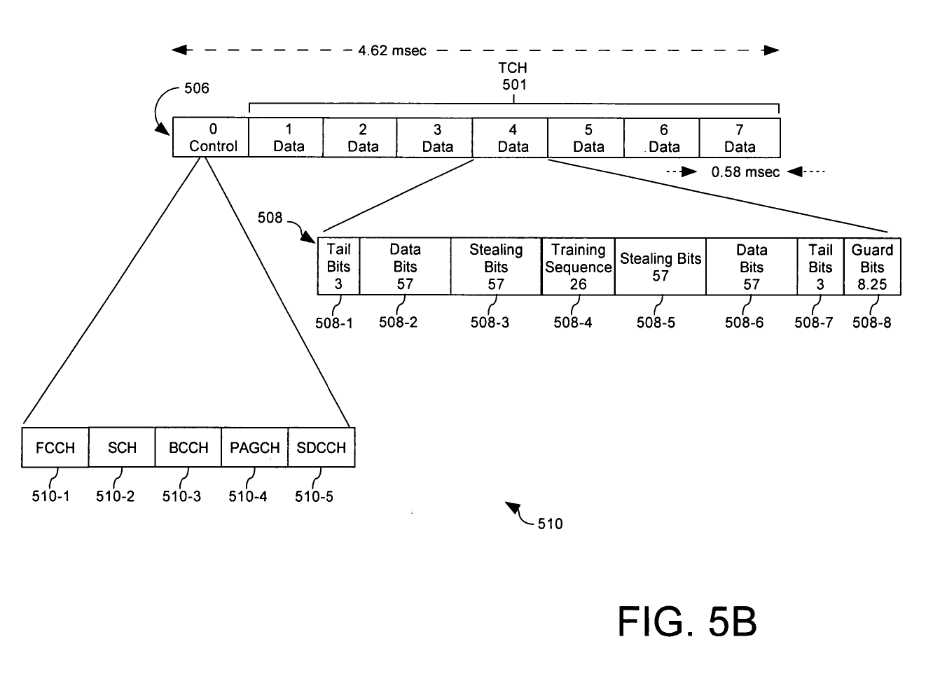

FIGS. 5a and 5b are useful for more fully understanding the signaling that occurs between a mobile station (MS) and a base transceiver station (BTS) during the handover process. FIG. 5a shows a typical uplink TDMA frame 400 comprising eight time slots, used for transmission to a BTS. In the GSM context, the time slots are called burst periods. The depicted GSM TDMA frame has a duration of 4.62 milliseconds, comprising eight burst periods, each having a duration of 0.58 milliseconds. Generally, for GSM type TDMA implementations which use a single RF carrier, one burst period is dedicated to transmitting control information, while the remaining burst periods are available to transmit traffic information. Traffic channels can carry conversations or data, as well as control information about mobile unit itself.

Referring to FIG. 5a, burst period 0 is a dedicated control channel while burst periods 1-7 support traffic. A full burst period of a given carrier frequency is commonly referred to as a channel. Portions of a burst period, or sub burst periods, assigned specific functions will be referred to herein as sub channels. Typical formats for the traffic sub channels and control sub channels are shown in burst period details 502 and 504, respectively. In GSM, there are 4 different types of bursts. These include (1) a normal burst, (2) a frequency correction burst, (3) a synchronous burst, and (4) an access burst. A normal burst is used to carry speech and data information. The structure of the normal burst is shown in detail 502. The frequency correction burst and synchronous burst have the same length as a normal burst. They have different internal structures to differentiate them from normal bursts. The frequency correction burst is used in Frequency Correction Channels (FCCH) and the synchronous burst is used in Synchronization Channels (SCH).

Detail 502 of a normal burst period 4 shows typical GSM format traffic sub channels including tail bits 502-1 and 502-7 which are used to indicate the beginning and end of a burst period. Data bits 502-2, 502-6 contain the digitized call information, while training sequence bits 502-4 are used for equalization of multi path signals. Stealing bits 502-3, 502-5 are provided to indicate if suppression of burst period data and replacement with priority data is requested. Finally, guard bits 502-8 are provided to keep the individual slots from overlapping upon receipt. The number of bits contained in a typical traffic sub channel is shown below the sub channel designation in detail 502.

As noted earlier, in TDMA RF carrier implementations, one burst period will generally be a digital control channel. As shown in detail 504 of burst period 0, sub channels in the uplink control burst period generally include a stand alone dedicated control sub channel (SDCCH) 504-1 and a random access sub channel (RACH) 504-2. The SDCCH sub channel 504-1 is used to complete call setup and for transmission of messages. The RACH sub channel 504-2 is used by mobile users 18 to transmit an access burst for requesting a dedicated channel from the BTS.

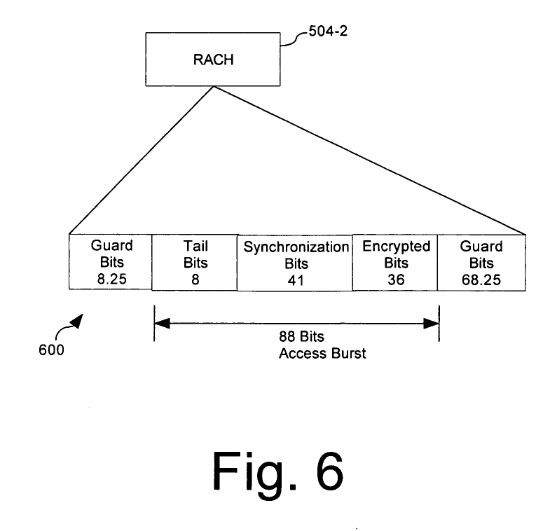

The access burst is shorter than a normal burst, and is generally used on the RACH channel described in relation to FIG. 5a. The access burst structure is shown in greater detail in FIG. 6. As illustrated therein, an access burst 600 can typically consist of 88 bits (compared to 148 bits for a normal traffic burst). These 88 bits can include 8 external tail bits 502, 41 synchronization bits, and 36 encrypted bits. 8.25 Guard bits precede the access burst and 68.25 guard bits follow the access burst. The access burst structure in FIG. 6 is typical of that used in GSM systems. However, it should be understood that the invention is not limited to the specific burst structure used in the GSM architecture.

FIG. 5b shows a typical GSM type eight burst TDMA frame 506 used in BTS to MS downlink communications. Generally, the information format in the traffic burst periods 1-7 remains the same compared to the uplink, but more control sub channels are included in the control burst period 0 (compared to the corresponding uplink control channel in detail 504), as shown in detail 510. Specifically, downlink control burst period 0 is comprised of a frequency correction sub channel (FCCH) 510-1, synchronization sub channel (SCH) 510-2, broadcast control sub channel (BCCH) 510-3, paging and access grant sub channel (PAGCH) 510-4 and SDCCH downlink sub channel 510-5. Every GSM cell broadcasts exactly one FCCH and one SCH, which are defined to be on time slot 0 in the TDMA frame. The FCCH sub channel 510-1 transmits frequency correction information for an MS 102 to correct its time base, while the SCH 510-2 sub channel transmits synchronization information for the mobile to synchronize to the framing structure of the network. The BCCH 510-3 sub channel transmits information to idle mobile users 18 such as local area identification and neighbor cell information. The PAGCH 510-4 sub channel is used to page a mobile and grant access to a MS 102 during call set up. Finally, four SDCCH subchannels 510-5 are used to transmit call setup information from BTS 106 to MS 102 to complete call setup.

Although FIG. 5b illustrates a downlink control burst period 0 with a SDCCH subchannel 510-5 and a FCCH subchannel 510-1, a person skilled in the art will appreciate that the downlink control burst period 0 may or may not comprise a SDCCH subchannel 510-5. Also, a person skilled in the art will appreciate that one or more of the burst periods 1-7 may comprise eight SDCCH subchannels 510-5 in place of a traffic channel (TCH).

A fast associated control channel (FACCH) carries the same information as the SDCCH. However, the SDCCH exists on its own, whereas the FACCH can replace part or all of a traffic channel. If at some time there is a need for a great deal of control information (e.g., during handoff), then the FACCH takes over the traffic channel (i.e., steals bursts). The flag bits indicate if the normal burst has been replaced with FACCH signaling information. Generally, the FACCH message is divided and transmitted over 8 sequential channel bursts and the speech information that would normally be transmitted is discarded. When received, the FACCH message is reassembled into its original message structure. FACCH messages can be transmitted on the uplink or downlink channel. The burst structure and timing described herein is typical of that used in GSM systems. However, it should be understood that the invention is not limited to the specific burst structure used in the GSM architecture. Accordingly, the foregoing information is provided merely as an aid to understanding the invention.

Notably, a person skilled in the art will appreciate that a GSM system is typically comprised of a plurality of carrier frequencies, for example, the primary GSM frequency band at near 900 MHz consists of one hundred twenty four (124) carrier frequencies. Each carrier frequency is divided in time, using a TDMA scheme. As shown above, the TDMA scheme can include a TDMA frame with seven burst periods. According to an embodiment of the invention, the handover process described below may be performed on a carrier frequency other than the carrier frequency with the TDMA scheme described above. For example, the handover process described below may be performed on a different carrier frequency than the carrier frequency divided in time using a TDMA frame with a downlink control burst period having a BCCH 510-3 sub channel, a FCCH sub channel 510-1, and a SCH sub channel 510-2.

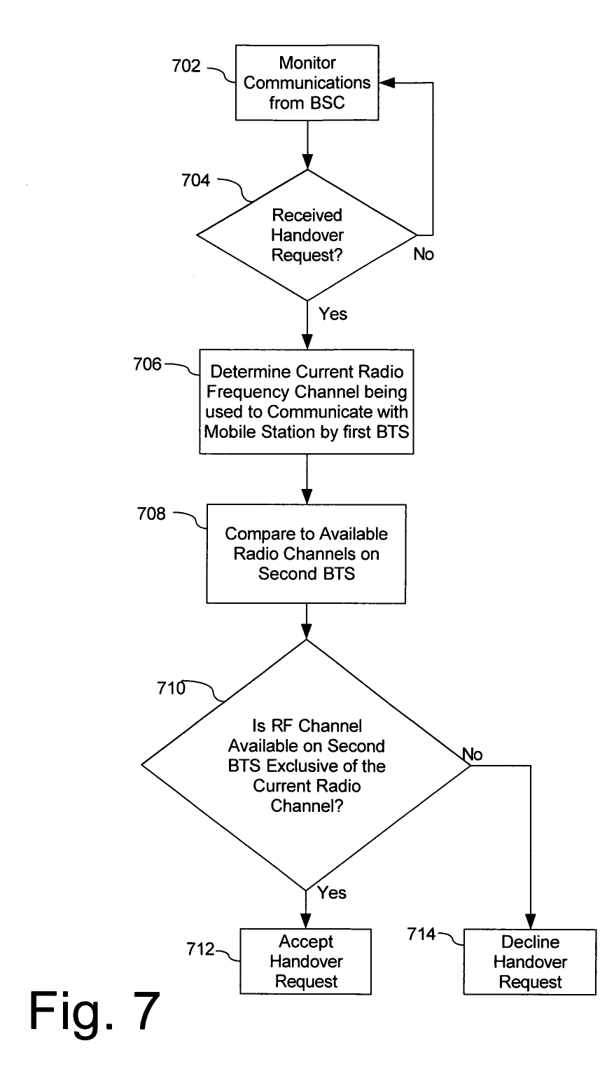

Referring now to FIG. 7, there is shown a flow chart that is useful for understanding a first embodiment of the invention. The method is useful for coordinating transference of service for a MS call signal from a first BTS to a second BTS in a wireless mobile telecommunication system. The method is particularly applicable where the first and second BTS include use a set of shared or common radio frequency channels for traffic communications with mobile stations. The method eliminates the possibility that communications on the second BTS will be initiated on the same frequency as service on the first BTS. Such a handover can result in high levels of interference at the mobile unit and can result in dropped calls.

In FIG. 7, the handover process can begin in step 702. In step 702, a base transceiver or BTS can monitor communications from a BSC. When such communications are received, the BTS can determine in step 704 if the communication from the BSC is a handover request message. The handover request message is essentially a request for the BTS to provide a telecommunication service to a MS that is currently being serviced by another BTS. For example, this can occur when the MS is currently obtaining such telecommunication service from another BTS but is moving out of range of range of that station.

When the handover request is received, the BTS can determine in step 706 a current radio frequency channel in use by the MS to communicate with the other BTS. In step 708, this current radio frequency channel can be compared to a set of available radio channels on which the MS could obtain the required telecommunication service from BTS that received the handover request. The purpose of the comparison can be to determine if the set of available radio channels includes at least one post-handover radio frequency channel for communications between the mobile and the BTS exclusive of the current radio channel.

In step 710, the BTS can determine if there is at least one frequency channel available on which the BTS can communicate with the MS that will not cause interference with the first base transceiver station's communications on the current radio channel with the mobile. In step 712, if there is at least one available radio frequency channel that is exclusive of the current radio channel the mobile is using to communicate with the other BTS, then an acceptance of the handover request can be communicated in step 712. This acceptance can be transmitted to the originating base station controller either directly or via a common mobile services switching center (MSC). Conversely, in step 714, a refusal of the handover request can be communicated by the BTS if the set of available radio channels does not include at least one post-handover radio frequency channel exclusive of the current radio channel. In this way, co-channel handovers can be avoided.

The various steps described herein with respect to the BTS can be performed by the control processor 280. However, the invention is not limited in this regard. Accordingly, the process can also be implemented in any other suitable combinations of processing hardware and software programming available on the BTS.

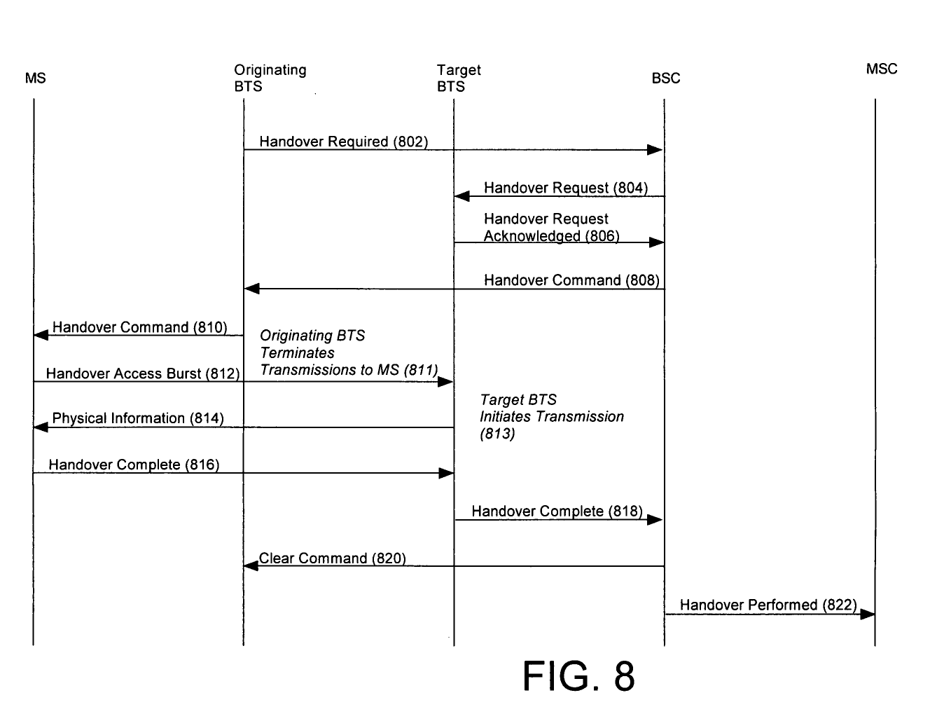

Referring now to FIG. 8 there is shown a message flow diagram that depicts an intercell handover process where the originating and target cells are managed by the same BSC. The message flow can be somewhat different where the target cells are managed by different BSCs. However, the handover process in FIG. 8 is nevertheless useful for understanding the invention.

Referring now to FIGS. 1-3 and 8, the originating BTS 106-1 can send a handover request notification message 802 to the BSC 108-1. The message 802 will notify the BSC 108-1 that a handover is required for a particular mobile station MS 102. The BSC will forward the handover request to target BTS 106-2 in a message 804 to notify the BTS 106-2 that it is to begin serving MS 102. This request will be acknowledged to the BSC 108-1 by the BTS 106-2 in a message 806. In a conventional handover process, the target BTS 106-2 would now begin transmitting to MS 102. This can be observed in the conventional process shown FIG. 4. However, in order to avoid potential co-channel interference, this transmitting step can be delayed in the present invention in order to accommodate the possibility of a co-channel handover.

In response to the handover request acknowledgement from BTS 106-2, the BSC 108-1 can send a handover command message 808 to originating BTS 106-1. Once the handover command message is received by BTS 106-1 it will forward the handover command message to MS 102 in message 810. In a conventional handover arrangement, the originating BTS 106-1 would generally continue to transmit to the MS 102 on its designated radio frequency communication channel subsequent to transmitting this handover command message 810. This can be observed in FIG. 4. However, in the present invention, the originating BTS in step 811 terminates transmissions to the MS 102 as shown in FIG. 8.

In step 812, MS 102 will initiate a radio link with the BTS 106-2. For example, MS 102 can send a handover access burst to BTS 106-2 to initiate the radio link. For example, this access burst can be transmitted on a TCH/FACCH channel. In response to this access burst, the BTS 106-2 can in step 813 finally begin transmitting. Notably, transmissions occurring at this point in time will not interfere with transmissions from the originating BTS, since the originating BTS has already terminated transmissions to MS 102.

In step 814, the target BTS will respond to MS 102. For example, the target BTS can respond with a physical information message 814. The physical information message 814 can include physical channel information for MS 102 to use when communicating with the target BTS 106-2. In step 816, the MS 102 can acknowledge this channel information by communicating to the BTS 106-2 that the handover is complete. Typically, in a GSM system, this message is communicated by the MS 102 using a TCH/FACCH channel. However, the invention is not limited in this regard. In step 818, BTS 106-2 can forward this confirmation to the BSC 108-1. BTS 106-2 can in turn communicate a clear command message 820 to the originating BTS 106-1 to indicate that it is no longer responsible for communicating with MS 102. The BSC can also in step 822 send a message to report to the MSC 112 that the handover is complete. Notably, the foregoing process allows co-channel handovers to occur without dropped calls. More particularly, co-channel interference can be avoided by ensuring that the target and the originating cell never transmit on the same channel at the same time.

Abnormal Conditions

Those skilled in the art will appreciate that there may be situations when the co-channel handover process does not progress properly through all of the various steps in the intended manner. This can be caused by a variety of factors and is not unusual. However, the co-channel handover process advantageously includes suitable contingent procedures to manage the occurrence of such abnormal handovers. The various types of handover failures and the contingent procedures for responding to such abnormal conditions will now be discussed.

Missed Handover Command

It may be noted that in FIG. 8, the handover command 810 is not generally acknowledged by a specific response message from MS 102 to the originating BTS 106-1. Accordingly, the originating BTS 106-1 has no direct means to verify that the handover command has been properly received by MS 102. Instead, a target BTS will normally initiate a timing interval after receiving a handover request. The timing interval establishes a waiting period during which the target BTS will wait to receive the handover access burst from the MS. In an ideal situation, the handover access burst will be received from MS 102 during this time period. However, a handover failure can occur when the MS does not properly receive the handover command in step 810. In that case, MS 102 will never initiate communications with the target BTS in step 812. Accordingly, the target BTS 106-2 will never initiate transmissions to MS 102 and the call will be dropped. Appropriate procedures must be available to address this potential problem.

One way to address the foregoing problem of a potentially missed handover command is for the originating BTS 106-1 to continue to monitor transmissions from MS 102 after BTS 106-1 transmits the handover command in step 810. During this time period, BTS 106-1 terminates transmissions to MS 102, but continues to monitor the communication channel to determine if any further messages are transmitted to it from MS 102. Examples of messages received from the MS 102 can include a signal measurement report that the MS 102 routinely sends to the BTS that is servicing the MS.

The BTS 106-1 can initiate a timer to give MS 102 an opportunity to process the handover command in step 810. For example, this timing function can be provided by control processor 280. If, after a pre-defined time period as measured by the timer, the originating BTS 106-1 receives no further messages from MS 102, then the absence of such messages can be taken to mean that the MS has processed the handover command and is being serviced by the target BTS 106-2. However, if the originating BTS 106-1 continues to receive messages from MS 102 after the expiration of the predetermined time period, then this can be taken as an indication that MS 102 did not receive the handover command in step 810. Consequently, the originating BTS 106-1 can resume service to MS 102 by restarting transmissions from the originating BTS to the MS 102. Notably, the foregoing procedure ensures that the originating BTS 106-1 will not attempt to communicate with the MS at the same time as the target BTS 106-2. This is especially advantageous in the case of co-channel handovers where such concurrent transmissions may interfere with each other at the MS.

A second alternative to address the problem of a potentially missed handover command also relies upon the originating BTS 106-1 continuing to monitor transmissions from MS 102. This monitoring can occur after BTS 106-1 transmits the handover command in step 810. During this time period, BTS 106-1 terminates transmissions to MS 102, but once again continues to monitor the communication channel. Although the handover command in step 810 is not directly acknowledged, the originating base station can check to determine if Layer 2 (data link) frames are acknowledged. In this embodiment, the originating BTS 106-1 can terminate transmissions only after receiving an acknowledgement of data link frames that contained the handover command message. The acknowledgement of the data link frames is an indirect indication that the MS has received the handover command in step 810.

Missed Handover Access Message

Another potential abnormal condition that can occur during the handover process is the case where the handover access burst in step 812 is not received by the target BTS 106-2. The MS can attempt to access the target BTS 106-2 by transmitting the handover access burst in step 812. However, if the target BTS 106-2 is unable to detect this message, it will not respond. This failure can be caused by a variety of factors including interference from another co-channel mobile or other sources.

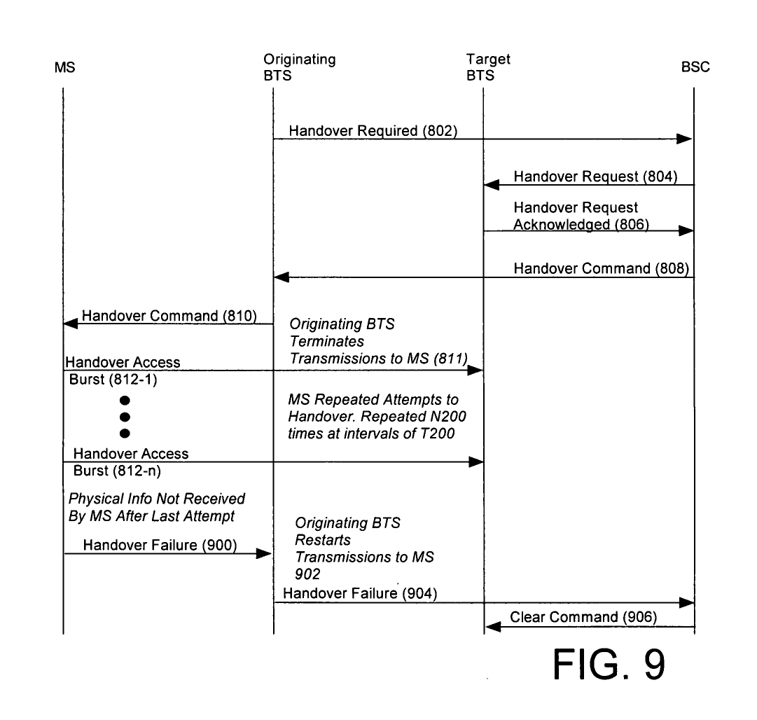

FIG. 9 shows how the foregoing failure can be processed. In FIG. 9, steps 802 through 811 are performed as previously described in relation to FIG. 8. In step 812-1, the MS 102 can begin transmitting a series of handover access bursts to initiate communications with the target BTS. These repeated attempts can be performed N200 times at intervals of T200. If the target BTS does not respond after handover access burst 812-n, then the MS 102 can transmit a handover failure message to the originating base station in step 900. Thereafter, in step 902, the originating BTS can re-start transmissions to the MS. The originating BTS 106-1 can also send a handover failure message to the target BTS in step 904. Finally, the BSC can send a clear command to the target BTS 106-2 in step 906.

FIG. 9 can be summarized as follows. Until the MS receives and decodes a information message from the target BTS 106-2, it will repeatedly transmit the handover access message for a defined (N200) number of times at a defined (T200) interval. If the mobile does not receive a physical information message from the target BTS, the MS will return to the originating BTS. Since the target BTS never detects and decodes the handover access message in step 812, it will not initiate transmissions. Once the originating BTS 106-1 detects a valid message (e.g. handover failure message) from the MS, it will resume transmissions to the MS 102. Notably, the foregoing procedure ensures that the originating BTS 106-1 will not attempt to communicate with the MS at the same time as the target BTS 106-2. This is especially advantageous in the case of co-channel handovers where such concurrent transmissions may interfere with each other at the MS.

Missed Physical Information Message

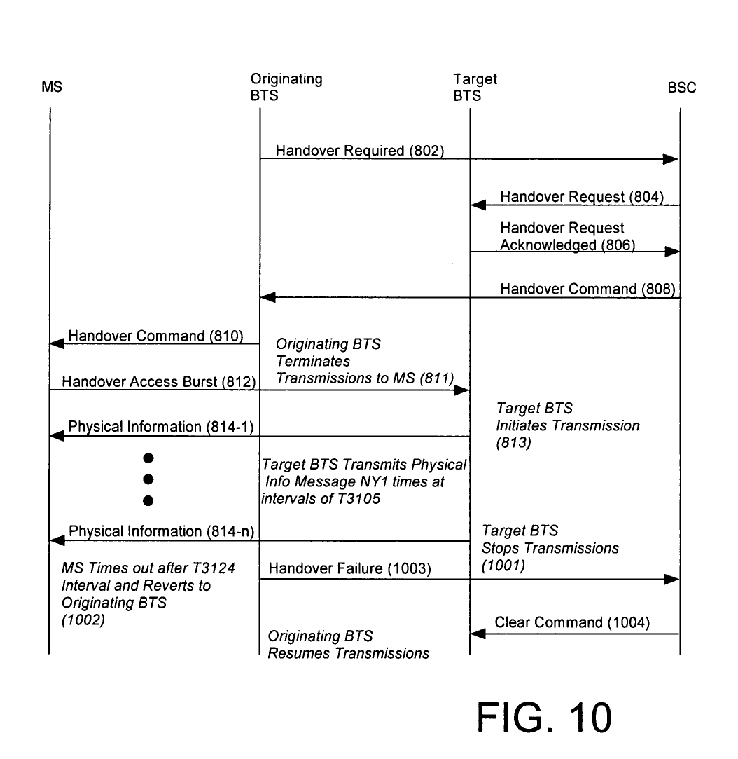

Referring now to FIG. 10, the next possible error scenario is that the target BTS 106-2 properly decodes a handover access message in step 812, and in return transmits a physical information message 814-1 to the MS 102. In this error scenario, MS 102 cannot decode the physical information message. For example, this inability to decode can be caused by interference from a BTS other than the originating BTS 106-1. As a result, the MS will not respond with a handover complete message. Consequently, the BTS will repeatedly transmit the physical information message to the MS for a defined number (Ny1) number of times and at a defined (T3105) interval. Following step 814-n, the target BTS 106-2 will stop transmitting its physical information to the MS 102.

When the MS sends the first handover access message in step 814-1, it also starts a timer to measure a defined timing interval (T3124). For example, the timing interval can be measured by an onboard processor (not shown) that is associated with the MS 102. At the end of that timing interval T3124 the MS will revert to originating BTS 106-1 in step 1003. Thereafter, the MS will transmit a handover failure message in step 1003. When the originating BTS detects and properly decodes a message from the MS, it will restart transmissions to the mobile.

In order to avoid the potential for co-channel interference caused by concurrent transmissions from the originating BTS 106-1 and the target BTS 106-2, the target BTS 106-2 should advantageously stop transmissions of physical information (step 814-n) before the originating BTS resumes transmitting. Accordingly, the target BTS can stop transmissions prior to expiration of this the T3124 timer or after the last transmission of the physical information message 814-n, whichever occurs sooner. This ensures that the target BTS does not interfere with the transmissions of the originating BTS after the originating BTS receives the handover failure message in step 1002.

According to another aspect of the invention, the target BTS could stop transmissions upon detecting a handover failure message transmitted by MS 102 to the originating BTS 106-1. Since all of these transmissions are co-channel on the RF frequency for communications with the target BTS and the originating BTS, the target BTS can monitor transmissions from MS 102 to detect the transmission of the handover failure message in step 1002.

Soft Handover

The foregoing techniques make it possible for handover to occur from one BTS while allowing the MS to remain on the same RF frequency channel. Significantly, these co-channel handover techniques also create the potential for what shall be referred to herein as a “soft handover”. A soft handover is an alternative to the normal handover of telecommunication service responsibility from an originating BTS to a target BTS. Because the MS uses the same RF frequency channels for communications both before and after the handoff, it is possible to perform the handover of service responsibility from an originating BTS to a target BTS without notifying the mobile that such a handover has taken place. In other words, there is no need to command the MS to handover to the RF frequency channel of the target BTS if it is the same channel that the MS is currently using. Consequently, the handover can be managed entirely on the network side without involving the MS.

To support the soft handover process described above, the time slots of the cells in the network must be synchronized with one another. GSM based telecommunications networks include the option of time slots that are synchronized from one cell to the next. Accordingly, that feature can be implemented in a GSM type network in which the soft handover network feature is to be implemented.

It may be expected that the timing advance between the target and originating BTS may typically differ slightly from one another in a GSM based system. However, it can be anticipated that the handover process will generally take place when the MS is approximately equidistant from the originating and the target BTS. Consequently, the difference between the timing advance associated with the target BTS and the originating BTS will generally be minimized. In fact, it can be anticipated that the difference between the timing advance of the originating and target BTS will not exceed that of the guard period between time slots for the target cell.

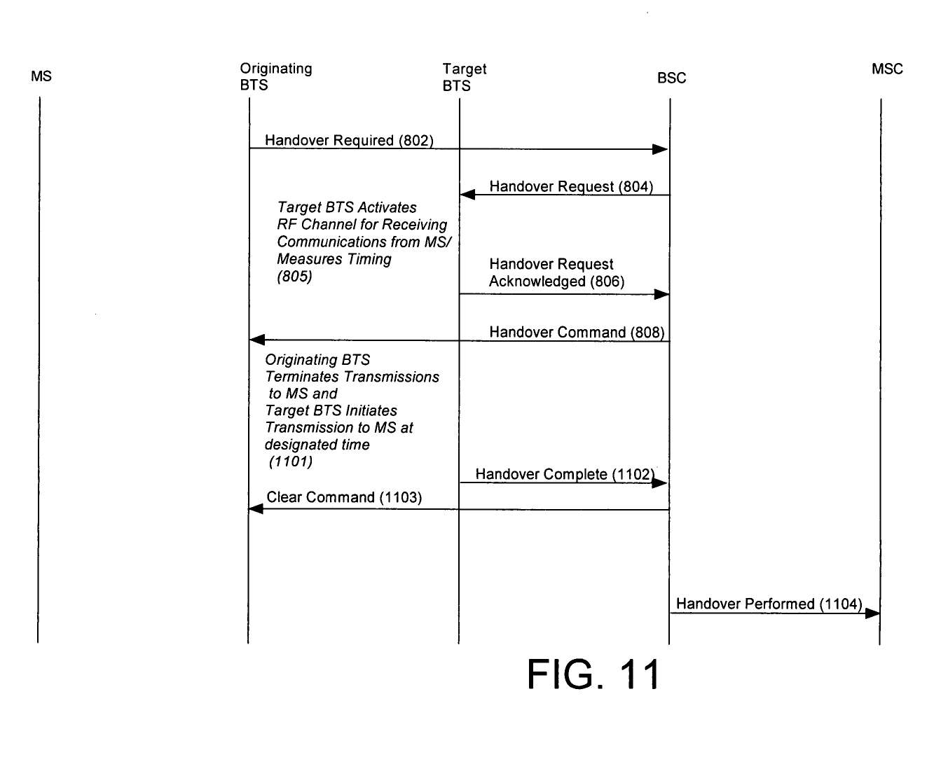

Referring now to FIG. 11, there is provided a process flow diagram that is useful for understanding the soft handover process. In FIG. 11, steps 802 through 808 can be generally performed as previously described in relation to FIG. 8. For this method, however, the target BTS should be informed that the originating BTS is co-channel to the target BTS. This information can be provided in the handover request message in step 804. In GSM based systems, the handover request message supports an optional informational element to pass physical channel information of the originating BTS to the target BTS. Accordingly, the target BTS can compare the physical channel information of the originating BTS to a list of available radio frequency channels on the target BTS 106-2 for providing telecommunication services to the MS 102. If the available channels include the same RF frequency channel, then the method for soft co-channel handover can proceed in step 806. In step 805, the target BTS 106-1 can activate an RF frequency channel for receiving communications from MS 102. At this time, the target BTS 106-2 advantageously does not begin transmissions to the MS 102. In step 805, the target BTS 106-2 can also begin measuring the timing of the transmissions from the MS 102. The target BTS can use this information to determine if a soft handover can be performed. If the difference between the timing advance of the originating BTS and target BTS for communications with the MS 102 does not exceed the guard period, then a soft handover can be supported. In step 806, as part of the handover request acknowledged message, the target BTS 106-2 can indicate whether or not a soft handover can be supported. If the soft handover request cannot be supported, then a conventional handover process could be performed as previously described in relation to FIGS. 1-8. If the soft handover can be supported, then the originating BTS 106-1 could pass a frame number on the air interface indicating the specific frame when the soft handover is to occur. The originating BTS 106-1 would assume that the handover would occur at a point in time defined as a predetermined number of frames from its current frame number.

In step 808, the BSC would transmit a handover command message to the originating BTS 106-1. The handover command message would indicate if a soft handover is to occur. The handover command message can also include an informational element that indicates the frame number from the originating BTS 106-1, when the soft handover is to occur. In step 1101, at the corresponding frame number for the soft handover, the originating BTS would stop transmissions and the target BTS would start transmissions.

In step 1102, the target BTS would indicate that it had successfully captured the MS and send a Handover Complete message to the BSC. The originating BTS 106-1 would then receive a Clear command from the BSC in step 1103 that would deactivate the channel on the originating BTS 106-1. As shown in the diagram, no specific handover messaging is required to or from MS 102 for the soft handover. Notably, the foregoing handover scenario does deviate from the GSM standard for information included in the handover messages. Information regarding whether a soft handover may occur, as well as information concerning the frame number from the originating BTS, can be communicated in the Handover Request Acknowledged message. The frame number as well as soft handover indication can be communicated in the Handover Command to the target BTS 106-2.

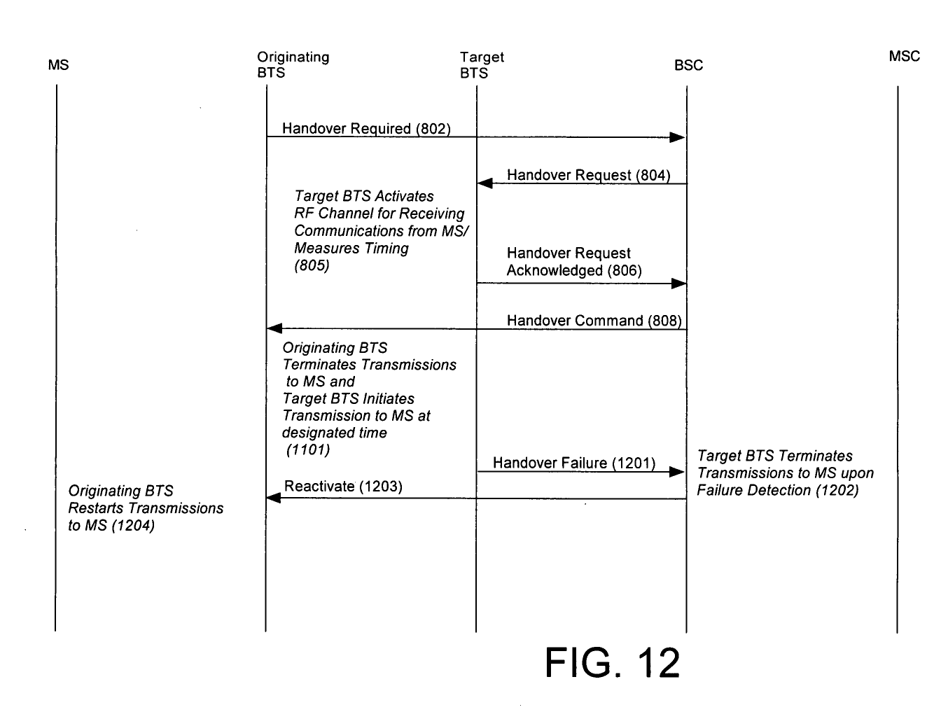

Referring now to FIG. 12, there is shown a process for managing failures during the soft handover process. In FIG. 12, steps 802-808, and 1101 occur as previously described in relation to FIG. 11. However, if for some reason the target BTS 106-2 failed to capture the MS 102 on the soft handover, it would send a Handover Failure message in step 1201 and stop transmissions. If the frame number to stop transmissions had not occurred, the originating BTS would not need to re-start transmissions. In step 1203, the originating BTS would be sent a Reactivate command. The reactivate command could cause the BTS to reactivate transmissions if transmissions had already stopped, or to ignore the Handover Command if the frame number had not occurred to stop transmissions.

We claim:

1. A method for transferring service for a mobile station call signal from a first base transceiver station operating on a first plurality of radio frequency channels, to a second base transceiver station operating on a second plurality of radio frequency channels in a wireless mobile telecommunication system while a call is in progress, where said first and said second plurality of radio frequency channels include a plurality of common radio channels, comprising:
receiving a handover request message at said second base transceiver station, said handover request message comprising a request for said second station to provide a telecommunication service to a mobile station that is currently serviced by said first base transceiver station;
comparing a current radio channel from said first plurality of radio frequency channels that is currently in use by said mobile station to communicate with said first base transceiver station, to a set of available radio channels among said second plurality of frequency channels on which said mobile station could be provided said telecommunication service on second base transceiver station;
determining if said set of available radio channels includes at least one post-handover radio frequency channel for communications between said mobile and said second base transceiver station exclusive of said current radio channel.

2. The method according to claim 1, further comprising the step of communicating an acceptance of said handover request by said second base transceiver if said set of available radio channels includes said at least one post-handover radio frequency channel exclusive of said current radio channel.

3. The method according to claim 1, further comprising the step of communicating a refusal of said handover request by said second base transceiver if said set of available radio channels does not include said at least one post-handover radio frequency channel exclusive of said current radio channel.

4. A method for transferring service for a mobile station call signal from a first base transceiver station operating on a first plurality of radio frequency channels, to a second base transceiver station operating on a second plurality of radio frequency channels in a wireless mobile telecommunication system, while a call is in progress, where said first and said second plurality of radio frequency channels include a plurality of common radio channels, comprising:
receiving a handover command message at said first base transceiver station providing a telecommunication service to a mobile station on a pre-handover RF channel used by said first base transceiver station to communicate with said mobile station;
responsive to said handover command message, terminating RF transmissions from said first base transceiver station to said mobile station on said pre-handover RF channel;
automatically continuing said telecommunication service for said mobile station using said second base transceiver station, said second base transceiver station providing said telecommunication service for said mobile station on a post-handover radio frequency channel that is the same as the pre-handover radio frequency channel.

5. The method according to claim 4, wherein said second base transceiver station begins transmitting on said post-handover RF channel after said terminating step.

6. The method according to claim 4, wherein said first base transceiver station transmits a handover command message to said mobile station prior to said terminating step, said handover command message directing said mobile station to continue said telecommunication service with said second base transceiver station.

7. The method according to claim 6, further comprising continuing to monitor transmissions from said mobile station at said first base transceiver station after said handover command message is transmitted.

8. The method according to claim 7, further comprising terminating said transmissions to said mobile station from said first base transceiver station immediately after said handover command message is transmitted.

9. The method according to claim 8, further comprising re-starting transmissions from said first base transceiver station to said mobile station on said pre-handover RF channel if said first base transceiver station continues to receive messages directed to said first base transceiver station from said mobile station after a pre-determined period of time.

10. The method according to claim 8, further comprising selecting said messages from the group consisting of (1) a signal measurement report from said mobile station, and (2) a handover failure message indicating that the mobile station has been unable to obtain said telecommunication service from said second base transceiver station.

11. The method according to claim 7, further comprising terminating said transmissions to said mobile station from said first base transceiver station only after receiving at said first base transceiver station at least an indirect acknowledgment of said handover command from said mobile station.

12. The method according to claim 11, further comprising selecting said indirect acknowledgment to include an acknowledgment of receipt of a data frame by the mobile station, wherein said data frame is known by said first base transceiver station to contain said handover command.

13. The method according to claim 4, further comprising beginning transmissions from said second base transceiver station to said mobile station on said post-handover radio frequency channel after receiving a handover access message from said mobile station requesting telecommunication services to be provided by said second base transceiver station.

14. The method according to claim 13, further comprising automatically terminating transmissions from said second base station to said mobile station if a message confirming that the handover process is complete is not received by said second base station prior to transmission of an information message from said second base transceiver station to said mobile station a predetermined number of times at a predetermined time interval, or within a first predetermined time period.

15. The method according to claim 14, further comprising transmitting a handover failure message from said mobile station to said first base transceiver station on said pre-handover RF channel if an information message from said second base transceiver station is not received by said mobile station within a second predetermined time period.

16. The method according to claim 15, further comprising terminating transmissions from said second base station to said mobile station prior to transmitting said handover failure message.

17. The method according to claim 4, further comprising releasing a telecommunication resource of said first base transceiver station from service with respect to said mobile station only after said second base transceiver station receives a message from said mobile station confirming that said telecommunication service with said second base transceiver station has been established.

18. The method according to claim 4, wherein prior to said terminating step, said first base transceiver station communicates with said mobile station during a first burst period, and said second base transceiver station communicates with said mobile station during a second burst period, and said first and second burst periods are substantially overlapping in time.

19. The method according to claim 4, wherein, said terminating step and said step of continuing said telecommunication service for said mobile station using said second base transceiver station occur exclusive of any notification to said mobile station.
